(19) United States
(12) Patent Application Publication
(10) Pub. No.: US 2025/0262613 A1
(43) Pub. Date: Aug. 21, 2025

(54) RARE EARTH AND GROUP 4 CATALYSTS FOR AMBIENT CONVERSION OF DINITROGEN TO SECONDARY SILYLAMINES

(71) Applicant: THE REGENTS OF THE UNIVERSITY OF CALIFORNIA, Oakland, CA (US)

(72) Inventors: Polly Arnold, Berkeley, CA (US); Anthony Wong, Berkeley, CA (US); Francis Lam, Berkeley, CA (US); Matthew Hernandez, Berkeley, CA (US); Michael Trinh, Berkeley, CA (US)

(73) Assignee: THE REGENTS OF THE UNIVERSITY OF CALIFORNIA, Oakland, CA (US)

(21) Appl. No.: 19/080,804

(22) Filed: Mar. 15, 2025

Related U.S. Application Data
(63) Continuation of application No. PCT/US2023/074839, filed on Sep. 22, 2023.
(60) Provisional application No. 63/409,429, filed on Sep. 23, 2022.

(51) Int. Cl. B01J 31/22; B01J 37/00; B01J 37/03; B01J 37/04; B01J 37/06; C01C 1/04; C01C 1/16

(52) U.S. Cl. CPC B01J 31/2239; B01J 31/2295; B01J 37/009; B01J 37/031; B01J 37/04; B01J 37/06; C01C 1/0411; C01C 1/164; B01J 2231/62; B01J 2531/0216; B01J 2531/0238; B01J 2531/38; B01J 2531/46

(57) ABSTRACT

Catalysts and methods for dinitrogen conversion to secondary silyamines or ammonia (N₂RR) are provided. The catalysts are a metalacyclic platform characterized by a pocket with tunable dimensions and conditions. The catalysts show dramatically improved N₂RR activity compared to previously reported early d-block catalysts. The tetraphenolate-supported bimetallic lanthanide or group IV metal complex undergoes multiple two-electron reductions, the last of which leads to the reductive activation of dinitrogen. The inclusion of a weak acid and silyl electrophiles during the reduction enables the catalytic conversion of N₂ to purely secondary amines.

### CROSS-REFERENCE TO RELATED APPLICATIONS

This application claims priority to, and is a 35 U.S.C. § 111(a) continuation of, PCT international application number PCT/US2023/074839 filed on Sep. 22, 2023, incorporated herein by reference in its entirety, which claims priority to, and the benefit of, U.S. provisional patent application Ser. No. 63/409,429 filed on Sep. 23, 2022, incorporated herein by reference in its entirety. Priority is claimed to each of the foregoing applications.

The above-referenced PCT international application was published as PCT International Publication No. WO 2024/064862 A1 on Mar. 28, 2024, which publication is incorporated herein by reference in its entirety.

### STATEMENT REGARDING FEDERALLY SPONSORED RESEARCH OR DEVELOPMENT

This invention was made with government support under Contract No. DE-AC02-05CH11231 awarded by the U.S. Department of Energy. The government has certain rights in this invention.

### BACKGROUND

### 1. Technical Field

This technology pertains generally to catalyst constructs and methods for fabrication and more specifically a class of inexpensive dinitrogen catalysts from earth-abundant metals (e.g., lanthanides and Ti, Zr, Hf, etc.) that make asymmetric amines directly, at ambient conditions, so they can be used for more advanced amine synthesis in remote or sensitive locations.

### 2. Background

Dinitrogen (N₂) with a N≡N triple bond is a challenging molecule to activate and reduce to useful products such as ammonia, and the energy intensive Haber-Bosch process is essentially the only industrial process that uses N₂ as a feedstock. The process typically combines N₂ with H₂ to make ammonia, NH₃, under high temperature and pressure conditions over a heterogeneous iron-based catalyst along with additives such as potassium to increase the rate of N₂ surface adsorption and to prevent catalyst poisoning.

Dinitrogen (N₂) binding to d-block complexes has been widely studied since the 1960's and hundreds of d-block dinitrogen, N₂, complexes have now been reported. Nevertheless, the strong N≡N bond (BDFE=945 KJ mol⁻¹) and large HOMO-LUMO gap (10.82 eV) result in a high activation energy and a significant energy input requirement for the nitrogen reduction reaction, N₂RR.

Electron-rich, mid-and late-d-block metal complexes have traditionally used monometallic complexes with a single redox-active center to bind end-on N₂ which is most reactive towards further functionalization. However, lower dⁿ metal complexes do not have enough valence electrons to fully reduce the bound, activated N₂ unit, and an external source of electrons is needed to achieve a catalytic transformation of N₂ in any system.

One approach has been the use of a family of Mo-based PXP (X=C, N, P) pincer complexes to convert N₂ to ammonia, starting from yields of 12 equiv. ammonia per Mo atom, then progressively higher turnovers, most recently into the thousands, through extensive catalyst optimization cycles involving tuning of both the ligands and reaction condition optimization. However, all these catalyst approaches require an external source of electrons for turnover whose cations can also contribute to stabilization of the intermediates.

As such, multi-metallic homo-and hetero-bimetallic frameworks are of increasing interest in the development of simple, ambient temperature/pressure conversions of N₂ into reduced and functionalized products. Still, electropositive metal complexes are rarely suggested as N₂RR candidates.

Another approach was the reaction of Ti(OiPr)₄ with lithium, 45 Me₃SiCl, and dinitrogen (1 atm) that gave a mixture assumed to contain [ClTi=NSiMe₃], [Cl₂Ti—N(SiMe₃)₂], and N(SiMe₃)₃ which could be converted into ammonia by treatment with HCl.

Therefore, there is a need for improved catalysts, processes and methods that can convert atmospheric dinitrogen into ammonia or directly into amines at ambient temperatures and pressures.

### BRIEF SUMMARY

Catalysts and methods for dinitrogen conversion to secondary silyamines by a nitrogen reduction reaction (N₂RR) are provided. The catalysts of the family have a metalacyclic platform with lanthanide or Group IV metals that are made from cheap, abundant, non-toxic, aryloxides that show dramatically improved N₂RR activity compared to previously reported early d-block catalysts. The metalacyclic platform of the catalysts is characterized by a pocket with tunable dimensions and conditions that can also help control the catalytic conversion of N₂ to bis(silyl)amines, over the tris(silyl)amines made by all of the other d-block catalysts. The simple metalacyclic complexes can catalyze the conversion of N₂ to bis or tris(silyl)amines in ambient conditions. The unusual double-substitution product is attributed to the control afforded by the metalacycle's pocket.

The platform is illustrated with bimetallic Ti and Zr (group IV) and Ln and Sm (lanthanide) complexes which use a tetraanionic, chelating tetraphenolate to bridge the two metal centers in a 2+2 metalacylic architecture (i.e., M₂L₂) are capable of binding dinitrogen in the cavity formed by the ligands upon reduction by more than eight electrons, even in a potentially competing donor solvent (e.g., such as tetrahydrofuran (THF)). This enables the catalytic functionalization of di-nitrogen within the cavity, and the addition of a weak acid and chlorosilanes in the presence of excess group 1 metal reductant generates secondary silylamines in up to 31.1 equivalents.

The 2+1 bimetallic platform analogues are also capable catalysts, and kinetic analyses suggest that the secondary amine is the favored product in this system. These are the first non-radioactive complexes capable of selective catalytic dinitrogen conversion to secondary silylamines.

Isolation and characterization of the 2, 4, 6-electron-reduced, and N₂-bound intermediates suggests that reduction of the ligand helps in the overall six-electron reduction needed to convert N₂ to amine products. The lower activity of the Zr analogue suggests that the ability to reduce the metal is also helpful in the N₂ reduction reaction process. The better selectivity for the secondary amine for Ti (vs. Zr) and Rb (vs. the smaller group 1 reductants) supports the suggestion that N₂ reduction and functionalization is occurring in a constricted space between the two metals.

The tetraphenolate-supported bimetallic Ti complex undergoes multiple two-electron reductions, the last of which leads to the reductive activation of dinitrogen. The inclusion of at least one weak acid and silyl electrophiles during the reduction enables the catalytic conversion of N₂ to purely secondary amines. Preferred electrophiles are chlorosilanes such as ClSiMe₃. Yields of up to 35.9 equivalents of amine per complex may be produced under ambient conditions. The Zr analogue is also a competent catalyst.

In one embodiment, a catalyst composition comprising a tetravalent metalacyclic complex of a metal selected from the group of group IV metals and at least one metal-tetraphenol (H₄L) ligand, where L=[{2-(OC₆H₂-2-tBu, 4-Me)₂CH}-1,3-C₆H₄]. In another embodiment, the catalyst composition has a 2:2 metal-to-ligand complex (M₂L₂). Another catalyst complex composition comprises a 2:1 metal-to-ligand complex M₂L₁.

In one preferred embodiment, the method comprises a method for the conversion of dinitrogen to secondary amines, the method comprising: (a) providing a catalyst of a tetravalent metalacyclic complex of a metal selected from the group of lanthanide metals and group IV metals and meta-phenyl-bridged tetraphenolate ligands; (b) providing dinitrogen source, a group 1 metal reductant, and an electrophile; (c) mixing the catalyst and an excess of reductant in tetrahydrofuran (THF) and nitrogen atmosphere to produce a first mixture; (d) adding the electrophile to the first mixture to produce a second mixture; (e) mixing the second mixture to complete the reaction; and (f) collecting the reaction products.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a schematic diagram of alternative preparative routes (a) or (b) to the catalyst structure (1−Ln), where Ln=Sm (n=1.5), Ce (n=2). The first route (a) is a salt elimination scheme with the steps (i) +4 KH, −2 H₂ (ii) +2 LnI₃(Et₂O)_{1.68}, −4 KI, THF, Ln=Sm (iii)+K₄(mTP), THF, −4 KI. The second route (b) is a protonolysis scheme with the steps: (i) 2 H₄(mTP)+2 LnN″₃, −6 HN″ (ii)+2 KN″, −2 HN″, THF. N″=N (SiMe₃)₂ according to one embodiment of the technology.

FIG. 2 is a depiction of the solid-state structure of 1-Sm. The THF, Hydrogen atoms, lattice solvent and the [K(THF)₆] counter-cation are omitted for clarity. The inter-lanthanide distances are Sm1−Sm2=9.3830 (7) Å and Ce1−Ce2=9.3706 (5) Å.

FIG. 3 is a diagram of N₂RR catalyzed by the lanthanide complexes 1−Ln. (a) ambient temperature and pressure formation of HN(SiMe₃)₂ from N₂ catalyzed by the lanthanide metallacycles 1-Ln, using a group 1 metal reductant M, trimethylchlorosilane and a weak acid; the conventional product N(SiMe₃)₃ can be made if acid is omitted.

FIG. 4 is a diagram of the synthesis of a reduced, N₂-containing intermediate 1-Sm—N₂ where rtp=room temperature and pressure and xs=excess.

FIG. 5 is a diagram of a tetravalent actinide complexes that can be used for the conversion of N₂ to silylamine.

FIG. 6 is diagram of a tetravalent group 4 (Ti) complex, that catalyzes the ambient conversion of N₂ to secondary amines HNR₂ according to one embodiment of the technology.

### DETAILED DESCRIPTION

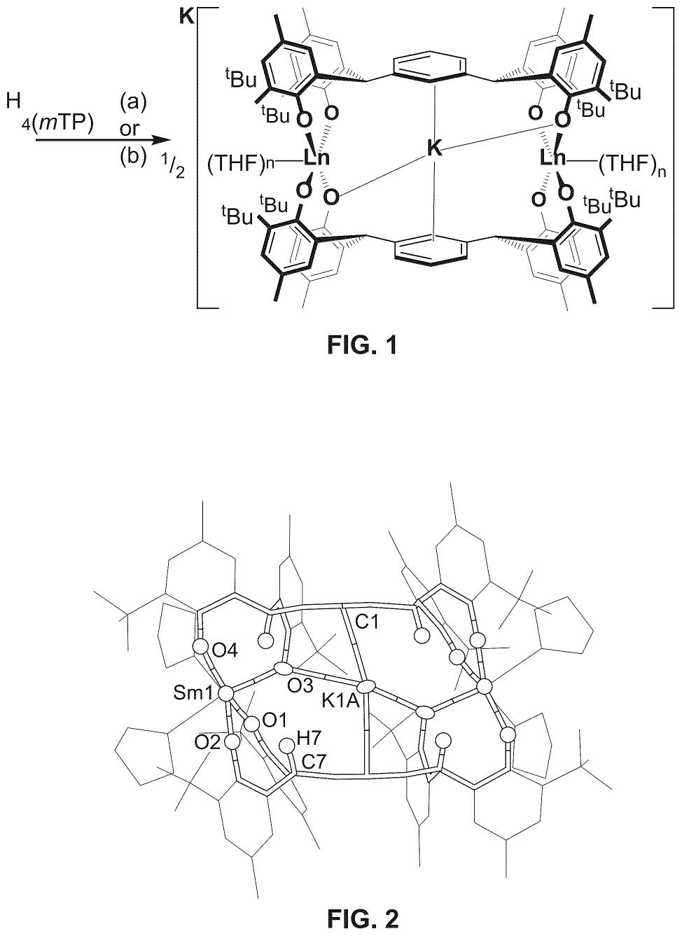

Referring more specifically to the drawings, for illustrative purposes, supramolecular nanocomposite compositions, systems and methods of fabrication and use are generally shown. Several embodiments of the technology are described generally in FIG. 1 to FIG. 6 to illustrate the characteristics and functionality of the compositions, systems, materials and methods. It will be appreciated that the methods may vary as to the specific steps and sequence and the systems and apparatus may vary as to structural details without departing from the basic concepts as disclosed herein. The method steps are merely exemplary of the order that these steps may occur. The steps may occur in any order that is desired, such that it still performs the goals of the claimed technology.

Turning now to FIG. 1, a generic lanthanide based metalacyclic complex N₂RR catalyst (1-Ln) is shown schematically. These metalacyclic complexes made from earth-abundant members of the lanthanide series or Group IV metals can catalyze the conversion of N₂ to bis or tris(silyl)amines in ambient conditions. Generally, the 1-Ln complexes shown in FIG. 1 can be prepared with a salt elimination route (e.g., +4 KH, −2 H₂ (ii) +2 LnI₃(Et₂O)_{1.68}, −4 KI, THF, Ln=Sm (iii) +K₄(mTP), THF, −4 KI) or a protonolysis route (e.g. 2 H₄ (mTP)+2 LnN″₃, −6 HN″ (ii) +2 KN″, −2 HN″, and THF). N″=N(SiMe₃)₂). Here, mTP is a meta-arene-bridged tetraphenolate ligand and THF is tetrahydrofuran. The tetraanion of the meta-phenyl-bridged tetraphenol proligand H₄(mTP) binds Lewis acidic metal cations via strong M—O bonds. Specific synthesis schemes for illustrative lanthanide complexes are also found in the examples.

The group of lanthanide based metalacyclic complexes are illustrated here with samarium (1-Sm) and cerium (1-Ce) complexes. A solid-state structure of 1-Sm is shown in FIG. 2 where the THF, hydrogen atoms, lattice solvent and the [K(THF)₆] counter-cation have been omitted for clarity. The inter-lanthanide distances are Sm1−Sm2=9.3830(7) Å and Ce1−Ce2=9.3706(5) Å in this illustration.

The 1-Sm structure shown in FIG. 2 is a colorless bis-Sm^{III} complex [K₂Sm₂(mTP)₂(THF)₃], in which two Sm^{III} cations are bound strongly, and held at a distance of a few angstroms by two O-donor tetraphenolates, mTP, is made from samarium salts and the tetraphenol H₄(mTP) under ambient conditions within a few hours by any of four different synthetic routes. The colorless cerium congener [K₂Ce₂(mTP)₂(THF)₄](1−Ce) is made similarly.

As shown in the embodiment of FIG. 2, one potassium counter-cation is located inside the cavity with bonds to two phenolate O atoms and an η¹ interaction with the central carbon in the bridging arene of each mTP; the arenes are co-planar but offset. The other K⁺ counter-cation is external and solvated by six THF molecules. The THF coordination draws each Sm^{III} away from the center of the cavity, enlarging it and enabling all four benzylic H to point inwards.

It can be seen that the dimensions and configuration of the pocket or cavity of the complexes as well as catalytic activity can be manipulated, in part, through the selection of the lanthanide or Group IV metal used in the complex. In the case of N₂, for example, the tetraphenolate complexes which contain both a pocket to bind N₂ and a reactive ligand C—H group to deliver a proton to the activated N₂ ligand resulting in the catalytic, reductive functionalization of N₂ to secondary silylamines. Likewise. Group 4 M^{IV} cations similarly demonstrate reductive activation of dinitrogen when supported by this strongly electron-donating, strongly binding tetraphenolate ligand platform.

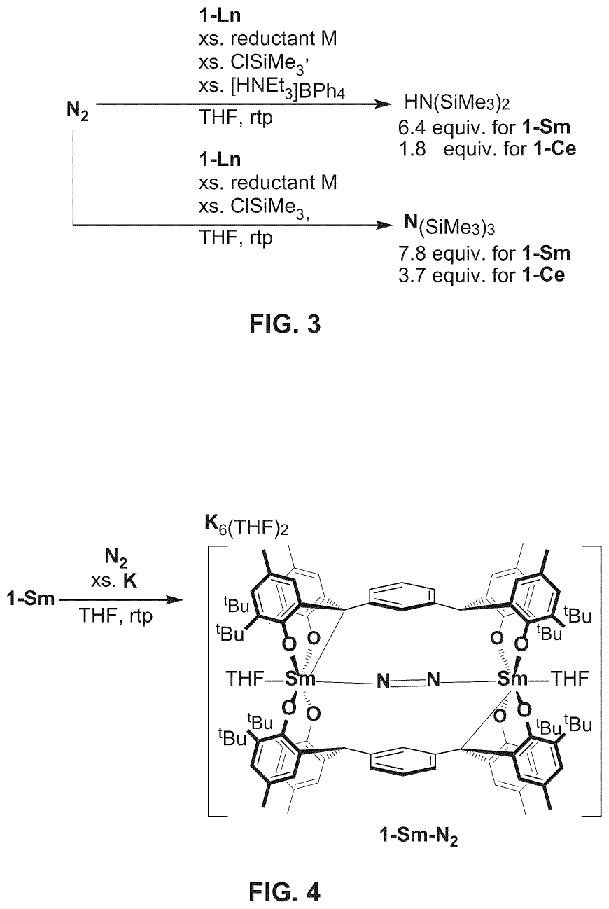

As illustrated in FIG. 3, the 1-Ln catalysts can catalyze the reductive functionalization of N₂ to the secondary silylamine HN(SiMe₃)₂ or N(SiMe₃)₃. The ambient temperature and pressure formation of HN(SiMe₃)₂ from N₂ catalyzed by the lanthanide metallacycles 1-Ln, using a group 1 metal reductant M, trimethylchlorosilane and a weak acid is shown in the top reaction of FIG. 3. The conventional product N(SiMe₃)₃ can be made if acid is omitted as shown in the lower reaction of FIG. 3. The synthesis of a reduced, N₂-containing intermediate 1-Sm—N₂ is shown in FIG. 4 where rtp=room temperature and pressure and xs=excess.

Under an atmosphere of N₂ and at room temperature, the complex 1−Sm catalytically converts dinitrogen to the bis(silyl)amine HN(SiMe₃)₂ in the illustration shown in FIG. 3. The reaction forms up to 6.4 equiv. of amine per 1-Sm in the presence of an excess of potassium or rubidium metal (a source of electrons), excess chlorotrimethylsilane MesSiCl (electrophile), and excess weak acid [HNEt₃][BPh₄]. A small amount of tris(silyl)amine N(SiMe₃)₃ may be formed as a by-product (0.3 equiv.). This product is typically formed by all d-block catalysts reported to date and tends to form at longer reaction times. Although the bis(silyl)amine is a more desirable product, the catalysis can be modified to give only N(SiMe₃)₃ by omitting the weak acid, yielding up to 7.8 equiv. of amine per 1−Sm as seen in the lower reaction of FIG. 3.

The Ln^{III}[mTP] metallacycles retain the features that characterized the robust An^{IV}[mTP] N₂RR catalysts including the stable metal oxidation state, strong M—O bonding, and a relatively short distance between the two Lewis acidic f-block cations. However, the ability to function in polar solvents, which suggests the chemical reductant in these reactions could be replaced by a greener electrochemical source of electrons in other embodiments.

The Ln-bound donor solvents in the 1-Ln complex make the pocket larger and places the ligand H further from the center. Both of these factors could explain why the formation of the tris(silyl)amine is facile for these catalysts, and the protons in HN(SiMe₃)₂ then can derive from the external proton source rather than the ligand benzylic groups. It is also most likely that the Ln valence orbitals are also involved in the electron transfer to the Ln-bound N₂.

Accordingly, lanthanide cations can catalyze the N₂RR reaction to make either HN(SiMe₃)₂ or N(SiMe₃)₃ amine from ambient, atmospheric dinitrogen, with a tetraphenolate ligand stabilizing the reducible pair of lanthanide ions as electrons and electrophiles are added to the lanthanide-bound dinitrogen molecule. The reactions use the most abundant of the lanthanides, and function in polar solvents, so one could imagine the eventual development of a catalysis that could convert N₂ to functionalized amines in remote locations.

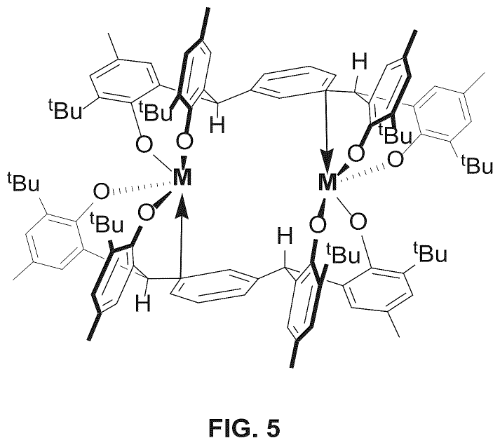

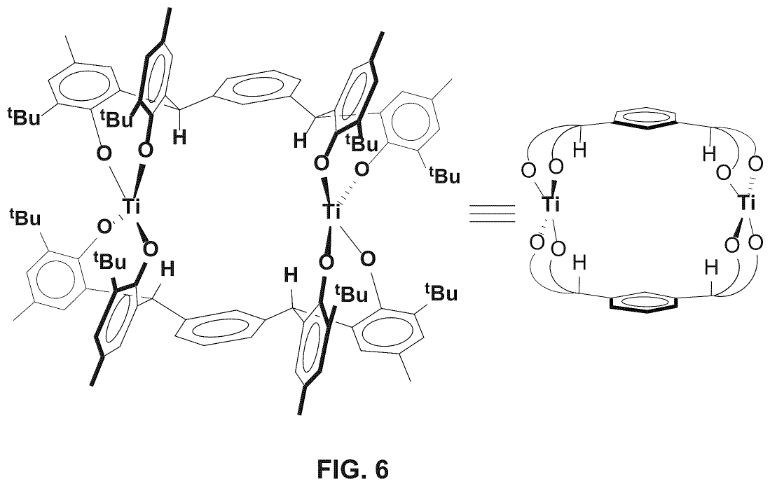

Referring now to FIG. 5 and FIG. 6, the general tetravalent actinide complexes and a tetravalent Group IV complex, that catalyzes the ambient conversion of N₂ to secondary amines HNR₂ are shown schematically.

To illustrate the platform with this group of metals, Ti and Zr 2+2 metallacyclic complexes (M₂L₂) of the same tetraanionic, chelating tetraphenolate ligands as the lanthanide metals were prepared and their capacity to support the reductive functionalization of ambient dinitrogen to secondary or tertiary silylamines was demonstrated.

Additionally, the 2+1 bimetallic platform complexes (M₂L₁), and simple monometallic Ti and Zr aryloxides can also catalytically convert N₂ to bis(silylamine) but are less active and less selective. The titanium complexes made from inexpensive, abundant, non-toxic, aryloxides demonstrated dramatically improved N₂RR activity compared to previously reported early d-block catalysts and the ligand framework can help control the catalytic conversion of N₂ to bis(silyl)amines, rather than tris(silyl)amine.

A protonolysis reaction between Ti(OiPr)₄, and the meta-tetraphenol (H₄L)(L=[{2-(OC₆H₂-2-tBu, 4-Me)₂CH}-1,3-C₆H₄]) in hot toluene affords a yellow precipitate of the 2:2 metal-to ligand complex Ti₂L₂ that is air-stable and has two distinct ligand environments in solution. Evaluation of the solid-state structure showed the metalacyclic motif featuring two tetrahedral Ti centers each surrounded by four X-type aryloxide donors. The shape and potential for reactivity of the metalacycle pocket is of greatest interest. The Ti—Ti distance is 7.89 Å and the average Ti—O distance is 1.81 Å, similar to other reported Ti aryloxides.

Stoichiometric and catalytic conversion of N₂ to HN(SiMe₃)₂ and N(SiMe₃)₃ and N₂ to NHₛ with the prepared complexes were evaluated. For the conversion of N₂ to NH₃ with Group IV catalysts, an excess reductant followed by the addition of a weak acid ([HNEt₃][BPh₄]) and catalyst generates ammonia. This gave an average yield of 0.78 equivalents of ammonia (38.5%) per complex.

To evaluate the catalytic conversion of N₂ to HN(SiMe₃)₂ and N(SiMe₃)₃, the catalysts were exposed to a THF solution with the addition of K metal (300 equiv) as reductant, and excess chlorosilane (ClSiMe₃) (225 equiv) and [HNEt₃][BPh₄] (131 equiv). This demonstrated catalytic formation of both HN(SiMe₃)₂ (29.4 equiv) and N(SiMe₃)₃ (5.35 equiv), as assayed by gas chromatography (GC) and ²⁹Si NMR spectroscopy.

Accordingly, the M₂L₂ metalacyclic Ti and Zr complexes are capable of binding dinitrogen in the cavity formed by the chelating aryloxide ligands upon reduction, even in competing donor solvents such as THF. The ligand architecture is flexible and allows the Ti—Ti distance to vary up to 0.9 Å upon reduction, which may help accommodate reduced, N₂-bound species along the catalytic cycle. The M₂L bimetallic platform and monometallic analogues are also capable catalysts. Isolation and characterization of the 2, 4, 6-electron-reduced, and the even more highly reduced N₂-bound complex that are all potential catalytic intermediates suggest ways the metallacycles can channel the six electrons and protons needed to convert N₂ to amine products.

DFT calculation of a possible N₂-containing dititanium intermediates in the catalysis finds end-on binding of dinitrogen to just one of the Ti centers, with interatomic distances and spin densities suggestive of activation to N₂.

Analogous calculations of a Ti(OAr)₄/N₂ complex yields geometric and spin density data very similar to those in the Ti₂ system. The N₂RR catalysis by 1-Zr is the first example for a zirconium complex, but the 1-Ti is more active, suggesting that the ability to reduce the metal is important in passing electrons to the bound N₂.

Other amines may also be selectively, catalytically made from dinitrogen with these catalysts. The more general capability of the Group 4 aryloxides to catalyze the formation of HN(SiMe₃)₂ also suggests that their relative reactivities with the acid and silyl electrophile are well matched in this system and may be extrapolated to other N₂RR catalysts.

The technology described herein may be better understood with reference to the accompanying examples, which are intended for purposes of illustration only and should not be construed as in any sense limiting the scope of the technology described herein as defined in the claims appended hereto.

### Example 1

In order to demonstrate the structure and functionality of the lanthanide based catalysts, the [K₂Sm₂(mTP)₂(THF)₃] (1-Sm) complexes were synthesized using one of four processes and analyzed.

In the first method, a magnetically stirred solution of H₄(mTP) (119.6 mg, 0.158 mmol) in THF (3 mL) was provided and the following added, in order: THF (3 mL) solutions of SmN″₃ (100.0 mg, 0.158 mmol) and KN″ (23.9 mg, 0.158 mmol). A colorless precipitate was formed after ca. 30 minutes of stirring. The reaction mixture was stirred for a further 16 hours, then [K₂Sm₂(mTP)₂(THF)₃], 1-Sm was isolated as a fine colorless powder by filtration and washed with THF (3×1 mL) and hexane (5×2 mL). Yield=136.2 mg, 85.1%. Crystals of 1-Sm suitable for single crystal X-ray diffraction were grown by slow diffusion of hexane into a saturated THE solution of 1-Sm. Crystals of the pyridine adduct [K(py)₆][Sm₂K(mTP)₂(py)₄]·3py, 1-Sm·py suitable for single crystal X-ray diffraction were grown by slow diffusion of hexane into a saturated pyridine solution of 1-Sm (py=pyridine).

In the second method using 2-Sm, a 20 mL scintillation vial was loaded with a magnetic stirrer bar to stir a suspension of KH (5.7 mg, 0.143 mmol, 4.2 equiv.) in THF (1.5 mL) and an added solution of H₄(mTP) (25.7 mg, 0.034 mmol, 1 equiv.) in THF (1.5 mL). The reaction mixture was allowed to stir for 3 hours until effervescence has stopped. The resultant yellow solution was filtered to remove unreacted KH. The filtrate was added to a solution of 2-Sm (60.0 mg, 0.034 mmol, 1 equiv.) in THF. A colorless suspension was formed after the reaction mixture was stirred for 16 hours. The colorless solution was isolated by filtration. The remaining solids were extracted in THF, and volatiles removed from the combined filtrate to yield 1-Sm as a fine colorless solid. Yield=38.3 mg, 55.6%.

A third method uses SmI₂(THF)₂, In this method, H₄(mTP) (107 mg, 0.141 mmol) and KCH₂C₆H₅ (76 mg, 0.57 mmol) were stirred in THF (1.5 mL), giving a dark solution. After a couple of minutes, a solution of SmI₂(THF)₂ in THF (1.5 mL) was added, and the dark brown suspension was stirred for one hour. The mixture was then dried under vacuum and then toluene (5 mL) was added. The mixture was centrifuged and then filtered, and the resulting dark orange solution was concentrated under vacuum to a volume of approx. 1 mL and then stored at −25° C. Colorless crystals of [K₂Sm₂(mTP)₂(C₇H₈)(THF)₃] (1-Sm·tol) deposited overnight.

A fourth methods is based on SmCl₃(THF)₂. A solution of KCH₂C₆H₅ (69 mg, 0.53 mmol) in THF (2 mL) was added to a stirring solution of H₄(mTP) (100 mg, 0.13 mmol) in THF (2 mL), and the mixture was stirred for two minutes, giving a dark solution. Then, SmCl₃(THF)₂ was added as a solid, along with 1 mL of THF. The mixture was stirred for several days and then dried under vacuum. Toluene (15 mL) was added to the residue, giving a yellow solution and a darkish solid. The mixture was then filtered and concentrated under vacuum to approximately 4 mL, and then stored at −25° C. Colorless crystals of 1-Sm tol deposited over the course of two weeks.

### Example 2

To further evaluate and characterize the structure and functionality of the lanthanide based catalysts, the [K₂Ce₂(mTP)₂THF)₃] (1-Ce) complex was synthesized and analyzed. To a magnetically stirred solution of H₄(mTP) (243 mg, 0.322 mmol) in THF (3 mL) was added CeN″₃ (200 mg, 0.322 mmol) in THF (3 mL) at −38° C., which resulted in a light-yellow solution. A KN″ (64.2 mg, 0.322 mmol) solution in THF (2 mL) was added immediately, yielding a colorless precipitate. The reaction mixture was stirred for 16 hours at room temperature and then filtered through a fine-porosity frit. The filter cake was washed with THF (4×0.5 mL) and hexanes (10×1 mL) and dried in vacuo to give the title compound [K₂Ce₂(mTP)₂(THF)₄] 1-Ce as a colorless solid (130 mg, 0.0605 mmol, 37.6% yield). Single crystals suitable for XRD studies were grown by slow vapor diffusion of hexanes into a saturated solution of 1-Ce in THF.

### Example 3

To further characterize the breadth of the lanthanide based catalysts, the Sm₂(mTP)I₂(THF)₆ (2-Sm) catalyst was synthesized and evaluated. In a 20 mL scintillation vial loaded with a magnetic stirrer bar, to a suspension of KH (26.1 mg, 0.651 mmol, 4.2 equiv.) was added a solution of H₄(mTP) (1 equiv.) in THF (117 mg, 0.155 mmol, 3 mL). The suspension was stirred for 3 hours until effervescence had stopped. The resultant yellow solution was filtered to remove unreacted KH. The filtrate was added to a suspension of SmI3(Et-2O) 1.68 (203 mg, 0.309 mmol, 2 equiv.) in THF (3 mL). The resultant suspension was stirred for 48 hours, after which it was filtered. Volatiles were removed under reduced pressure from the filtrate to yield Sm₂(mTP)I₂(THF)₆ (2-Sm) as a yellow powder. Crystals suitable for single crystal X-ray diffraction were obtained by slow diffusion of hexane into a solution of 2-Sm in THF.

In another illustration, [K₆Sm₂(N₂)(L)₂(THF)₄] (2-Sm) was produced with 1-SM as a component. In a 20 mL scintillation vial loaded with a magnetic stirrer bar was added a suspension of 1-Sm (50.0 mg, 0.025 mmol) in THF (10 mL) and several lumps of potassium metal (108.2 mg, 2.77 mmol, 111 equiv.). This mixture was stirred for 120 hours at room temperature. The resultant dark red solution was filtered, and the volatiles were removed under reduced pressure to yield [K₆Sm₂(N₂)(L)₂(THF)₄]2Sm as a dark red solid (55.2 mg, 95.1% based on the proposed molecular weight). The ¹⁵N₂-enriched isotopologue, ¹⁵N—2Sm, was synthesized using KC₈ (25 equiv.) as the reductant under a ¹⁵N₂ atmosphere.

### Example 4

Another lanthanide complex catalyst [K₆Sm₂(N₂)(mTP)₂(THF)₄] (1-Sm—N₂) was also synthesized to evaluate intermediates. In a 20 mL scintillation vial loaded with a magnetic stirrer bar was added a suspension of 1-Sm (50.0 mg, 0.025 mmol) in THF (10 mL) and several lumps of potassium metal (108.2 mg, 2.77 mmol, 111 equiv.). This mixture was stirred for 120 hours at room temperature. The resultant dark red solution was filtered, and the volatiles were removed under reduced pressure to yield [K₆Sm₂(N₂)(mTP)₂(THF)₄] 1-Sm—N₂ as a dark red solid (55.2 mg, 95.1% based on the proposed molecular weight). The ¹⁵N₂-enriched isotopologue, 1-Sm—¹⁵N₂, was synthesized using KC₈ (25 equiv.) as the reductant under a ¹⁵N₂ atmosphere.

### Example 5

To further demonstrate the breadth of the catalyst platform family, a tetravalent Group IV complex, that catalyzes the ambient conversion of N₂ to secondary amines was synthesized and evaluated. To a stirred solution of H₄L (L=2-(OC₆H₂-2-tBu, 4-Me) ₂C}-1,3-C₆H₄]) (1,000.0 mg, 1.324 mmol) in toluene (5 mL) was added Ti(OiPr)₄ (376.4 mg, 1.324 mmol) dropwise in toluene (5 mL). The resulting transparent red solution was sealed in a Teflon-valved ampoule and heated at 90° C. for 16 hours, which leads to the deposition of a bright yellow precipitate. The mixture was filtered using a fine porosity frit and the filter-cake was then washed with toluene (5×0.5 mL) and hexanes (5×1 mL) to give Ti₂L₂·2PhMe final material (1-Ti) as a bright-yellow powder (375.0 mg, 0.210 mmol, 31.8% yield).

A second crop of the product was obtained upon removal of the iPrOH byproduct from the filtrate under reduced pressure followed by dissolution into toluene and application of heat at 90° C. for an additional 16 hours, which similarly resulted in deposition of a bright yellow precipitate (600.0 mg, 0.337 mmol, 50.8% yield). Orange single crystals suitable for SCXRD studies were grown from a saturated benzene solution of the product overnight.

### Example 6

Another illustration of a Group IV catalyst platform is the synthesis of 1-Zr, believed to be the first zirconium based dinitrogen catalyst to be produced. To a stirred solution of H₄L (165.7 mg, 0.2194 mmol) in toluene (2 mL) was added ZrBn₄ (100.0 mg, 0.2194 mmol) dissolved in toluene (2 mL). The resulting golden-brown solution was allowed to stir at ambient temperature overnight, during which time a small amount of white precipitate forms and is subsequently removed by filtration. (Zr₂([{2-(OC₆H₂-2-^{t}Bu,4-Me)₂CH}-1,3-C₆H_{4]})₂)·2PhMe (i.e. Zr₂(L)₂)(1-Zr) was isolated as a pale-brown solid by solvent removal from the filtrate under vacuum, and washed with hexanes until the washings were colorless. The complex crystallizes from toluene or benzene; colorless block crystals (39.8 mg, 19% yield) suitable for SCXRD were grown by layering hexanes over a concentrated benzene solution.

Synthesis of Zr(OAr)₄. To a stirred solution of HOAr (OAr═OC₆H₃-2-^{t}Bu-4-Me) (288.2 mg, 1.755 mmol) in toluene (3 mL) was added ZrBn₄ (200.0 mg, 0.4388 mmol) dissolved in toluene (3 mL). The resulting brown homogeneous solution was allowed to stir at ambient temperature overnight, then the volatiles were removed under reduced pressure. The resulting brown residue was washed with cold hexanes, redissolved in HMDSO, and allowed to stand at −35° C. overnight to crystallize the product as colorless blocks. After decanting the mother liquor, the crystalline material was washed with HMDSO until the washings were colorless, then dried in vacuo to afford Zr(OC₆H₃-2-^{t}Bu-4-Me)₄(Zr(OAr)₄).

### Example 7

A further illustration of Group IV catalyst synthesis is for {TiCl₂(THF)}₂(L). To a stirred solution of H₄L (1,000.0 mg, 1.324 mmol) in THF (5 mL) was added TiCl(THF)₂ (884.3 mg, 2.648 mmol) in THF (5 mL). The solution darkened and settled on very dark red after 16 hours at room temperature. The solution was filtered using a fine porosity frit and the filter-cake was washed with THF (5×0.5 mL). The dark red filtrate was collected, and the volatiles were removed in vacuo to give a red oily residue. The addition of toluene (4 mL) led to the precipitation of a microcrystalline solid within 30 minutes. The toluene mother liquor was decanted and the resulting dark red crystalline material was washed with toluene (2×0.5 mL) and hexanes (2×0.5 mL) to give {TiCl₂(THF)}₂ (L) final product as a dark red solid after drying in vacuo (930.0 mg, 0.7061 mmol, 53.3% yield). Dark red single crystals suitable for SCXRD studies were grown by slow vapor diffusion of HMDSO into a saturated THE solution of the product overnight.

### Example 8

To further characterize the Group IV catalyst family, the catalyst [K₈(THF)₄Ti^{III}₂(N₂)(L⁻)₂](2Ti) was synthesized and evaluated. To a stirred suspension of 1Ti (100.0 mg, 0.0561 mmol) in THF (10 mL) was added KC₈ (189.6 mg, 1.403 mmol) suspended in THF (4 mL). The resulting mixture was stirred overnight and then filtered through a microporous glass filter to yield a dark-red filtrate. The volatile components were removed in vacuo and the red residue was treated with THF (2 mL) and allowed to stand at −38° C. overnight to precipitate the olive-green [K₆(THF)₈Ti^{III}₂(L²⁻)₂] K₆—1Ti byproduct. The dark-red filtrate was isolated by filtration and the volatiles were removed in vacuo and the remaining residue washed with hexanes (5×2 mL) to give [K₈(THF)₄Ti^{III}₂(N₂)(L⁻)₂] 2Ti as a dark-red powder (62.6 mg, 0.02813 mmol, 50.1% yield based on C₁₂₀H₁₅₄K₈N₂O₁₂Ti₂ formulation). ¹⁵N—₂Ti is made in an identical manner to that of 2Ti, except under an ¹⁵N₂ atmosphere. A crude ¹H NMR spectrum of 2Ti is included in the SI but has not been assigned. Raman (cm⁻¹):v(¹⁴N₂)=846; v(¹⁵N₂)=796. The value calculated for the ¹⁵N₂ isotopomer using the reduced mass formula is 817 cm⁻¹. The higher measured value is attributed to the involvement of adjacent heavy atoms in this stretching mode. Elemental analysis (%) calc. for C₁₂₀H₁₅₄K₈N₂O₁₂Ti₂ (2225.0744 g-mol⁻¹): C, 64.78; H, 6.98; N, 1.26. Found: C, 61.43; H, 6.25; N, 0.65. Due to the extreme sensitivity of 2Ti, suitable values for elemental analysis could not be obtained.

The K content was also evaluated. The solid was digested in concentrated HNO₃ (2.94 mL) (14.2 mg), and the mixture sonicated in a water bath for 10 minutes. The mixture was diluted to 100 mL and analyzed using ICP-OES. The Ti:K ratio was determined to be 1:4.10, which supports the Ti₂K₈ formulation.

### Example 9

To illustrate the function of the catalysts, several different catalyst embodiments were prepared and tested for dinitrogen reduction and the formation of HN(SiMe₃)₂ from N₂. Individual 1-M and 2-M catalysts were prepared and placed in Teflon-capped ampoules. Then a chunk of group 1 metal (Na⁰, K⁰, or Rb⁰), a magnetic stirrer bar, and THF (3 mL) were introduced to the vial and the mixture was stirred at room temperature for 24 hours or more and the mixture typically darkens over time. For example, the mixture was stirred at room temperature for 48 hours (1-Sm), 72 hours (1-Ce), or 20 hours (2-Sm).

To the resultant suspension was added both ClSiMe₃ via micropipette and [HNEt₃][BPh₄] in quick succession and the ampoule was sealed. The mixture was stirred for a specified time period at room temperature (see Table S1). The mixture was then frozen in N₂(I) and the headspace of the ampoule (ampoule A) was evacuated. The headspace of a second Teflon-capped ampoule (ampoule B) was similarly evacuated. The volatile components in ampoule A were then vacuum transferred via a trap-to-trap distillation into ampoule B. The solution was then prepared for GC analysis as follows: the contents of ampoule B were first diluted to 5 mL in volumetric flasks using THF. Then, an aliquot (typically 100 μL) from the 5 mL stock solution was taken up with a Hamilton glass syringe and further diluted to 2 mL. The resulting 2 mL stock solution was transferred into a glass GC vial (ca. 0.5 mL) and injected for analysis.

### Example 10

To demonstrate the catalyzed formation of N(SiMe₃)₃ from N₂, various catalysts were prepared and tested. The procedure for the formation of N(SiMe₃)₃ from N₂ mediated the group IV aryloxides are identical to that for the formation of HN(SiMe₃)₂, except that the proton source, [HNEt₃][BPh₄], was omitted. In this example, a Teflon-capped ampoule was initially charged with 1-Ln or 2-Sm, a chunk of group 1 metal (Na, K, or Rb), a magnetic stirrer bar, and THF (3 mL). The mixture was stirred at room temperature for 48hours (1-Sm), 72 hours (1-Ce), or 20 hours (2-Sm). To the resultant suspension was added Me₃SiCl via micropipette and the ampoule was sealed; typically, there was no immediate color change, but the mixture darkens over time. The mixture was stirred for a specified time period at room temperature. The mixture was then frozen in N_{2(L)} and the headspace of the ampoule (ampoule A) was evacuated. The headspace of a second Teflon-capped ampoule (ampoule B) was evacuated. The volatile components in ampoule A were then vacuum transferred via a trap-to-trap distillation into ampoule B.

The solutions were then prepared for further analysis.

### Example 11

Another illustration of the capabilities of the various catalysts is with the formation of NH₃ as NH₄Cl from N₂. In this illustration, a Teflon-capped ampoule was charged with an individual catalyst (1-M, 2-M or Kₙ-1M etc.), a chunk of potassium metal, a magnetic stirrer bar and THF (3 mL). The mixture was stirred for 24 hours and thereafter. [HNEt₃][BPh₄] (25 equiv.) was added to the resultant deep red solutions. The ampoule was then sealed, and the mixture allowed to stir for 24 hours. Typically, the suspension turns colorless within minutes. The mixture was then frozen in N₂ (/) and the headspace of the ampoule evacuated (ampoule A). To another Teflon-tapped ampoule (ampoule B) was charged 2 M HCl in Et₂O (ca. 2 mL). The contents of ampoule B were then frozen in N₂(I) and the headspace of the ampoule evacuated. The volatiles in ampoule A were then vacuum transferred via trap-to-trap distillation into ampoule B. Then, in a glovebox, KO^{t}Bu (100 equiv.) and THF (3 mL) were added into ampoule A. The ampoule was then sealed, and the mixture allowed to stir for 30 minutes. The mixture was then frozen in N₂(I) and the headspace of the ampoule evacuated again. The volatiles in ampoule A were then once again vacuum transferred into ampoule B. Once thawed, the volatiles were removed from ampoule B under reduced pressure to yield a colorless solid of [HNEt₃]Cl and NH₄Cl.

In another illustration, a Teflon-capped ampoule was charged with 1-Sm (10.0 mg, 0.0050 mmol), 1-Ce (10.0 mg, 0.0047 mmol) or 2-Sm (10.0 mg, 0.0058 mmol), a chunk of potassium metal, a magnetic stirrer bar and THF (3 mL). The mixture was stirred for 48 hours. [HNEt₃][BPh₄] (25 equiv.) was added to the resultant deep red solution (from 1-Ln) or brown suspension (from 2-Sm). The ampoule was then sealed, and the mixture allowed to stir for 24 hours. Typically, the suspension turns colorless within minutes. The mixture was then frozen in N_{2(I)} and the headspace of the ampoule evacuated (ampoule A). To another Teflon-tapped ampoule (ampoule B) was charged 2 M HCl in Et₂O (ca. 2 mL). The contents of ampoule B were then frozen in N_{2(I)} and the headspace of the ampoule evacuated. The volatiles in ampoule A were then vacuum transferred via trap-to-trap distillation into ampoule B. Then, in a glovebox, KO^{t}Bu (100 equiv.) and THF (3 mL) were added into ampoule A. The ampoule was then sealed, and the mixture allowed to stir for 30 minutes. The mixture was then frozen in N_{2(I)} and the headspace of the ampoule evacuated again. The volatiles in ampoule A were then once again vacuum transferred into ampoule B. Once thawed, the volatiles were removed from ampoule B under reduced pressure to yield a colorless solid of [HNEt₃]Cl and NH₄Cl.

### Example 12

The catalytic activity of the lanthanide-based catalysts was evaluated. Under an atmosphere of N₂ and at room temperature complex 1-Sm catalytically converts dinitrogen to the bis(silyl)amine HN(SiMe₃)₂, forming up to 6.4 equiv. of amine per 1-Sm in the presence of an excess of potassium or rubidium metal reductant (a source of electrons), excess chlorotrimethylsilane Me₃SiCl (electrophile), and excess of a weak acid [HNEt₃][BPh₄]. A small amount of tris(silyl)amine N(SiMe₃)₃ was formed as a by-product (0.3 equiv.) and this was a product formed by all d-block catalysts reported to date, and tends to form at longer reaction times. Although the bis(silyl)amine is a more desirable product, the catalysis can be modified to give only N(SiMe₃)₃ by omitting the weak acid, yielding up to 7.8 equiv. of amine per 1-Sm.

The Ln-bound donor solvents in 1-Ln make the pocket larger and places the ligand H further from the center. Both these factors could explain why the formation of the tris(silyl)amine is facile for these catalysts, and the protons in HN(SiMe₃)₂ then can derive from the external proton source rather than the ligand benzylic groups.

It is also most likely that the Ln valence orbitals are also involved in the electron transfer to the Ln-bound N₂. Therefore, a Ce^{III} analogue 1-Ce was created to test this feature because the formal Ce^{II} oxidation state would be extremely difficult to access in this O-donor ligand environment. The reduction potential for Sm^{III} is −1.55 V, that for Ce^{III} is −3.2 V versus SHE. Under the same reaction conditions used for 1-Sm, 1-Ce is less active for N₂RR, yielding 1.8 equiv. of bis(silyl)amine, or 3.7 equiv. of tris(silyl)amine respectively, per 1-Ce. This suggests that Ln cations which are easier to reduce to Ln^{II} provide more effective ways for electrons to be delivered to the Ln-bound N₂ during the catalysis. Potassium metal has a reduction potential of close to −3.0 V, but cannot reduce N₂ alone. Thus, even though it was not possible to isolate a Sm^{II} complex, the accessibility of the reduced Ln ion appears to help with catalysis.

It was shown that lanthanide cations can catalyze the N₂RR reaction to make either HN(SiMe₃)₂ or N(SiMe₃)₃ amine from ambient, atmospheric dinitrogen, with a tetraphenolate ligand stabilizing the reducible pair of lanthanide ions as electrons and electrophiles are added to the lanthanide-bound dinitrogen molecule. The reactions use the most abundant of the lanthanides, and function in polar solvents, so one could imagine the eventual development of a catalysis that could convert N₂ to functionalized amines in remote locations.

### Example 13

To further characterize the catalysts and dinitrogen conversion, the group IV based 2+2 and 2+1 complexes were prepared and functionally evaluated. The conversion of N₂ to NH was initially evaluated. The (1-Ti) complex was exposed to excess reductant (K0) followed by the addition of the acid ([HNEt₃][BPh₄]) which liberated any activated nitrogen as NH₃ in yields on a par with U2L2 (38.5%, 0.78 equiv.). To identify whether the NH protons originate from the ligand benzylic C(H) or the added acid, the isotopolog [DNEt₃][BPh₄] was used which gives ND₃ (isolated as ND₃HCl) by 2H NMR spectroscopy, confirming the protons originate from the added acid. To confirm the nitrogen containing acid is not the source of N, we repeated the experiment with phosphonium-based acid [HPCy3][Cl], which also yields ammonia (FIG. S9). An experiment using ¹⁵N₂ further confirms that ammonia derives from dinitrogen due to the presence of a doublet (δ=7.35 ppm, ¹JNH=71.3 Hz) for ¹⁵NH₄Cl in the 1H NMR spectrum.

The stoichiometric and catalytic conversion of N₂ to HN(SiMe₃)₂ and N(SiMe₃)₃ with the metal complexes under standard conditions involving the addition of K metal (300 equiv) as reductant to a THF solution of 1-Ti catalyst, then excess ClSiMe₃ (225 equiv) and [HNEt₃][BPh₄] (131 equiv) was evaluated. This resulted in the catalytic formation of both HN(SiMe₃)₂ (29.4 equiv) and N(SiMe₃)₃ (5.35 equiv), as assayed by gas chromatography (GC) and ²⁹Si NMR spectroscopy. The N(SiMe₃)₃ was a by-product from the secondary reaction of the newly formed HN(SiMe₃)₂ with K metal to form KN(SiMe₃)₂, which reacts with ClSiMe₃.

For example, aliquots of an N₂RR catalysis using 1-Ti under standard reaction conditions were removed periodically and analyzed to determine the extent of silylamine formation versus time. A relatively linear increase in the formation of HN(SiMe₃)₂ with time was observed for the first 8 hours and then plateaus and starts to decrease as N(SiMe₃)₃ by-product starts to grow in. In support of this, reactions in the absence of acid yield only sub-stoichiometric amounts of N(SiMe₃)₃ (<75%, 1.4 equiv.) and trace amounts of HN(SiMe₃)₂. Repetition of the procedure with half the amount of acid (65.6 equiv) leads to a reduction in total product formation HN(SiMe₃)₂ (9.3 equiv) and N(SiMe₃)₃ (12.8 equiv), implying that the favored product is HN(SiMe₃)₂ and that depriving the system of acid results in less product rather than more trissilylamine. The kinetic study using the standard conditions, except replacing [HNEt₃][BPh₄] with [DNEt₃][BPh₄], and a decrease in the overall rate of formation of H/DN(SiMe₃)₂ was observed, which suggested that N—H bond formation/cleavage is involved in the rate-determining step.

### Example 14

The reductant tunability was evaluated for optimal activity. A systematic evaluation of the Group 1 metal reductant shows K to be the most effective out of Na, K, or Rb tested for 1-Ti (M₂L₂), using the standard reaction conditions outlined above. Reduction with Na results in sub-stoichiometric yields of the silylamines (0.42 equiv HN(SiMe₃)₂; 0.43 equiv N(SiMe₃)₃), likely due to fast, unproductive reaction with the added acid, since a rapid generation of a gas presumed to be dihydrogen is observed. On the other hand, the increased ratio of secondary to tertiary amine product could be due to two different factors. First, in the sterically confined pocket of 1-Ti, it may be less likely that RbN(SiMe₃)₂ forms as a byproduct (from direct reaction with Rb metal). Second, the secondary reaction of the product HN(SiMe₃)₂ that forms N(SiMe₃)₃ could be slower or disfavored for the larger M═Rb. The pKM of group 1 metal amides decreases down the group for M, so the lower nucleophilicity of RbN(SiMe₃)₂ is less likely to form N(SiMe₃)₃. Similar trends are observed when using 2-Ti (M₂L₁) in combination with either Na (3.41 equiv HN(SiMe₃)₂; 2.33 equiv N(SiMe₃)₃) or Rb (12.6 equiv HN(SiMe₃)₂; 10.4 equiv N(SiMe₃)₃) compared with K.

### Example 15

The 2-Ti red 2:1 metal-to-ligand complex {TiCl₂(THF)}₂(L) (M₂L₁) is less active than 1-Ti but overall still more active for N₂RR than any other yet reported Ti complex, giving respectable yields of the secondary silylamine under standard conditions; HN(SiMe₃)₂ (15.9 equiv) and N(SiMe₃)₃ (3.9 equiv). These data imply that the 2+2 metallacycle is not essential for catalytic formation of the bis(silylamine). It is also instructive to compare the results to the aryloxides M(OAr)₄ that mimic just the core of 1-Ti. The homoleptic, monometallic complex for OAr=OC₆H₃-2-^{t}Bu-4-Me has been reported for Ti, and we have made Zr(OAr)₄. The titanium complex Ti(OAr)₄, yielded 16.8 equiv. of the bissilylamine, which is significant, but associated with this is 4 equiv. of the tris silylamine by-product. Even still, it is notable that the total conversion of N₂ and ratio of bis:tris silylamine is almost the same for the dititanium platform and the tetrakis aryloxide, suggesting that pre-organization of the metal centers is not necessary for catalysis.

From the description herein, it will be appreciated that the present disclosure encompasses multiple implementations of the technology which include, but are not limited to, the following:
A method for the conversion of dinitrogen to secondary amines, the method comprising: (a) providing a catalyst of a tetravalent metalacyclic complex of a metal selected from the group of lanthanide metals and group IV metals and meta-phenyl-bridged tetraphenolate ligands; (b) providing dinitrogen source, a group 1 metal reductant, and an electrophile; (c) mixing the catalyst and an excess of reductant in tetrahydrofuran (THF) and dinitrogen atmosphere to produce a first mixture; (d) adding the electrophile to the first mixture to produce a second mixture; (e) mixing the second mixture to complete the reaction; and (f) collecting the reaction products.

The method of any preceding or following implementation, wherein the lanthanide metals are selected from the group consisting of lanthanum (La), cerium (Ce) neodymium (Nd) and samarium (Sm).

The method of any preceding or following implementation, wherein the group IV metals are selected from the group consisting of titanium (Ti) and zirconium (Zr).

The method of any preceding or following implementation, wherein the meta-phenyl-bridged tetraphenolate ligands of the complex are selected from the group consisting of [{2-(OC₆H₂-2-tBu, 4-Me)₂CH}-1,3-C₆H₄] and mTP.

The method of any preceding or following implementation, wherein the catalyst complex comprises a 2:2 metal-to-ligand complex (M₂L₂).

The method of any preceding or following implementation, wherein the catalyst complex comprises a 2:1 metal-to ligand complex (M₂L₁).

The method of any preceding or following implementation, wherein the metal reductant is a metal selected from the group of metals consisting of sodium (Na), potassium (K) and rubidium (Rb).

The method of any preceding or following implementation, wherein the electrophile selected from the group consisting of chlorosilanes such as ClSiMe₃.

The method of any preceding or following implementation, wherein the nitrogen source comprises atmospheric nitrogen at room temperature and pressure.

The method of any preceding or following implementation, further comprising adding a proton source to the first mixture after the addition of the electrophile to produce the second mixture.

The method of any preceding or following implementation, wherein the proton source comprises a weak acid.

The method of any preceding or following implementation, wherein the weak acid comprises [HNEt₃][BPh₄].

The method of any preceding or following implementation, further comprising treating the collected reaction products with hydrochloric acid to produce ammonia.

The method of any preceding or following implementation, further comprising controlling the selection of the catalyst metal, complex dimensions and the composition of the reductant and electrophile to promote reaction products.

A catalyst composition comprising a tetravalent metalacyclic complex of a metal selected from the group of group IV metals and at least one metal-tetraphenol (H₄L) ligand, where L=[{2-(OC₆H₂-2-tBu, 4-Me)₂CH}-1,3-C₆H₄].

The catalyst composition of any preceding or following implementation, wherein the complex comprises a 2:2 metal-to-ligand complex (M₂L₂).

The catalyst composition of any preceding or following implementation, wherein the complex comprises a 2:1 metal-to ligand complex M₂L₁.

The catalyst composition of any preceding or following implementation, wherein the metal is a metal selected from the group consisting of Ti and Zr.

A catalyst composition comprising a tetravalent metalacyclic complex of a metal selected from the group of lanthanide metals and at least one meta-phenyl-bridged tetraphenolate ligand L=mTP.

The catalyst of any preceding or following implementation, wherein the lanthanide metals are selected from the group consisting of lanthanum (La), cerium (Ce) neodymium (Nd) and samarium (Sm).

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has. a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A method for the conversion of dinitrogen to secondary amines, the method comprising:
(a) providing a catalyst of a tetravalent metalacyclic complex of a metal selected from the group of lanthanide metals and group IV metals, and meta-phenyl-bridged tetraphenolate ligands;
(b) providing dinitrogen source, a group 1 metal reductant, and an electrophile;
(c) mixing the catalyst and an excess of reductant in tetrahydrofuran (THF) and dinitrogen atmosphere to produce a first mixture;
(d) adding the electrophile to the first mixture to produce a second mixture;
(e) mixing the second mixture to complete the reaction; and
(f) collecting the reaction products.

2. The method of claim 1, wherein said lanthanide metals are selected from the group consisting of lanthanum (La), cerium (Ce) neodymium (Nd) and samarium (Sm).

3. The method of claim 1, wherein said group IV metals are selected from the group consisting of titanium (Ti) and zirconium (Zr).

4. The method of claim 1, wherein said meta-phenyl-bridged tetraphenolate ligands of said complex are selected from the group consisting of [{2-(OC₆H₂-2-tBu, 4-Me)₂CH}-1,3-C₆H₄] and mTP.

5. The method of claim 1, wherein said catalyst complex comprises a 2:2 metal-to-ligand complex (M₂L₂).

6. The method of claim 1, wherein said catalyst complex comprises a 2:1 metal-to ligand complex (M₂L₁).

7. The method of claim 1, wherein said metal reductant is a metal selected from the group of metals consisting of sodium (Na), potassium (K) and rubidium (Rb).

8. The method of claim 1, wherein said electrophile comprises ClSiMe₃.

9. The method of claim 1, wherein said nitrogen source comprises atmospheric nitrogen at room temperature and pressure.

10. The method of claim 1, further comprising:
adding a proton source to the first mixture after the addition of the electrophile to produce the second mixture.

11. The method of claim 10, wherein the proton source comprises a weak acid.

12. The method of claim 11, wherein the weak acid comprises [HNEt₃][BPh₄].

13. The method of claim 1, further comprising:
treating the collected reaction products with hydrochloric acid to produce ammonia.

14. The method of claim 1, further comprising:
controlling the selection of the catalyst metal, complex dimensions and the composition of the reductant and electrophile to promote reaction products.

15. A catalyst composition comprising:
a tetravalent metalacyclic complex of a metal selected from the group of group IV metals and at least one metal-tetraphenol (H₄L) ligand, where L=[{2-(OC₆H₂-2-tBu, 4-Me)₂CH}-1,3-C₆H₄].

16. The catalyst composition of claim 15, wherein said complex comprises a 2:2 metal-to-ligand complex (M₂L₂).

17. The catalyst composition of claim 15, wherein said complex comprises a 2:1 metal-to ligand complex M₂L₁.

18. The catalyst composition of claim 15, wherein said metal is a metal selected from the group consisting of Ti and Zr.

19. A catalyst composition comprising:
a tetravalent metalacyclic complex of a metal selected from the group of lanthanide metals and at least one meta-phenyl-bridged tetraphenolate ligand L=mTP.

20. The catalyst of claim 19, wherein said lanthanide metals are selected from the group consisting of lanthanum (La), cerium (Ce) neodymium (Nd) and samarium (Sm).
